(19) United States
(12) Patent Application Publication
(10) Pub. No.: US 2018/0264946 A1
(43) Pub. Date: Sep. 20, 2018

(54) DYNAMIC AUDIO STEERING CONTROL SYSTEM

(71) Applicant: Harman International Industries, Incorporated, Stamford, CT (US)

(72) Inventor: Christopher Michael Trestain, Livonia, MI (US)

(73) Assignee: Harman International Industries, Incorporated, Stamford, CT (US)

(21) Appl. No.: 15/926,653

(22) Filed: Mar. 20, 2018

Related U.S. Application Data
(60) Provisional application No. 62/474,032, filed on Mar. 20, 2017.

(51) Int. Cl. B60K 35/00; H04S 7/00; H04R 3/12; H04R 5/02

(52) U.S. Cl. CPC B60K 35/00; H04S 7/30; H04R 3/12; H04R 2499/13; B60K 2350/905; B60K 2350/1056; H04R 5/02

(57) ABSTRACT

A sound signal distribution system comprising an audio system controller, an input signal representative of a vehicle steering angle received at the audio system controller, a pan control adjustment signal generated by the audio system controller and based on the input signal representative of a steering angle, a surround sound processing algorithm carried out in the audio system controller, the surround sound processing system receives the pan control adjustment signal and applies it to an incoming audio signal to generate an output audio signal supplied to at least one loudspeaker.

### CROSS REFERENCE TO RELATED APPLICATION

This application claims the benefit of U.S. Provisional Application Ser. No. 62/474,032, filed Mar. 20, 2017, the disclosure of which is incorporated in its entirety by reference.

### TECHNICAL FIELD

The present disclosure is directed to an audio control'system and more particularly to a dynamic audio control system.

### BACKGROUND

Consumers have a very high expectation for sound quality in vehicle audio systems. Vehicle audio systems incorporate advanced signal processing techniques that customize listening environments and provide unique sound experiences within a vehicle. Surround sound processors combine left and right input signals in different proportions to produce. However, such surround sound processors are templates that are stored and applied when selected by a user to create a fixed, or designated, audio experience in the vehicle based on the user selection. Sound processing criteria may also include a loudness function that varies a gain factor as a function of vehicle speed. However, various other factors in and around the vehicle also have an effect the vehicle audio system. Vehicle acceleration, vehicle lateral motion, vehicle location, and an environment of the vehicle location may all have an effect on the sound quality in a vehicle and therefore may have an effect on the driving experience. While a vehicle is in motion, disconnect may occur between the music experience and the driving experience. There is a need to enhance a driving experience by incorporating audio into the momentum of the vehicle.

### SUMMARY

A sound signal distribution system having an audio system controller, an input signal representative of a vehicle steering angle received at the audio system controller, a pan control adjustment signal generated by the audio system controller that is based on the input signal representative of a steering angle and a surround sound processing algorithm carried out in the audio system controller. The surround sound processing system receives the pan control adjustment signal and applies it to an incoming audio signal to generate an output audio signal supplied to at least one loudspeaker.

The sound signal distribution system may also receive an input signal representative of a vehicle acceleration. The pan control adjustment signal will be generated based on the input signal representative of the steering angle and the input signal representative of the vehicle acceleration.

### DESCRIPTION OF DRAWINGS

FIG. 1 generally depicts a vehicle listening environment having a system as described in one or more embodiments of the present disclosure;

FIG. 2 is a block diagram of an exemplary vehicle loudspeaker arrangement;

FIG. 3 is a block diagram of an audio distribution system in accordance to one embodiment;

FIG. 4 is a block diagram of a phase panner in accordance to one embodiment;

FIGS. 5A & 5B demonstrate first and second panner configurations for steering position input; and

FIG. 6 is a flow chart of a sound distribution system in accordance to one embodiment.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

### DETAILED DESCRIPTION

While various aspects of the present disclosure are described with reference to a particular illustrative embodiment, the present disclosure is not limited to such embodiments, and additional modifications, applications, and embodiments may be implemented without departing from the present disclosure. In the figures, like reference numbers will be used to illustrate the same components. Those skilled in the art will recognize that the various components set forth herein may be altered without varying from the scope of the present disclosure. All references to circuits or other electrical devices and the functionality provided by each are not intended to be limited to only what is illustrated and described herein. Such circuits and other electrical devices may be combined with or separated based on implementation. Further, controllers, processors, integrated circuits, memory devices, may be configured to execute a computer program that is embodied in a non-transitory computer readable medium that may be programmed to perform any number of functions.

Any one or more of the devices described herein include computer executable instructions that may be compiled or interpreted from computer programs created using a variety of programming languages and/or technologies. In general, a processor (such as a microprocessor) receives instructions, for example from a memory, a computer-readable medium, or the like, and executes the instructions. A processing unit includes a non-transitory computer-readable storage medium capable of executing instructions of a software program. The computer readable storage medium may be, but is not limited to, an electronic storage device a magnetic storage device, an optical storage device, an electromagnetic storage device, a semi-conductor storage device, or any suitable combination thereof. One or more devices may operate using a dedicated operating system, multiple software programs and/or platforms for interlaces such as graphics, audio, wireless networking, enabling applications, integrating hardware of vehicle components, systems, and external devices such as smart phones, tablets, and other systems to name just a few.

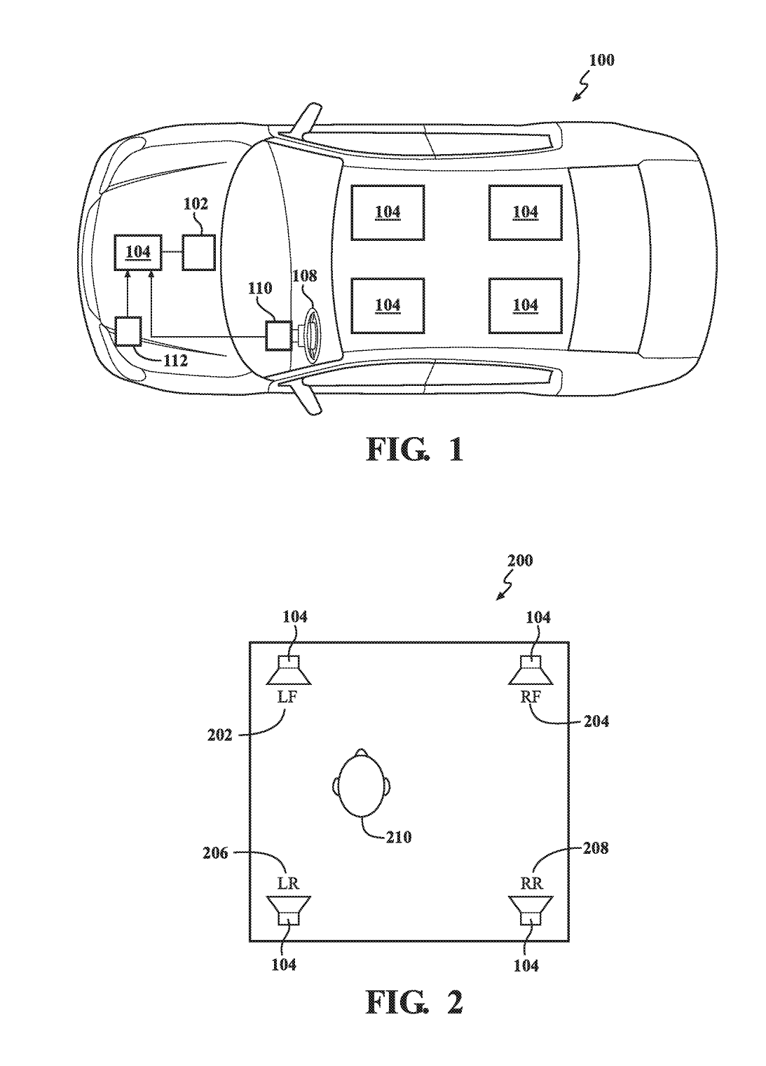

FIG. 1 generally depicts a vehicle 100. The vehicle 100 includes a vehicle audio system 102 arranged to playback audio within an interior of the vehicle 100. Within the vehicle, the vehicle audio system 102 communicates with a plurality of loudspeakers 104 positioned about the vehicle 100 to playback audio processed by a vehicle audio controller 106. The vehicle audio controller 106 may transmit signals to a plurality of loudspeakers 104 to provide an actively processed acoustic signal (not shown in FIG. 1).

The vehicle 100 also includes a steering wheel 108 and a steering position sensor 110 that generally provides information about steering wheel position, usually in the form a steering angle. The steering position sensor may be indicative of a vehicle heading. There are other systems, sensors, and information available on a vehicle and through vehicle systems that also may be indicative of vehicle heading. The steering position sensor 110 described herein is one example. A vehicle acceleration sensor 112 measures acceleration forces caused by movement of the vehicle and may also provide an input representative of a vehicle acceleration to the vehicle audio controller 106. Vehicle acceleration may also be determined from several sensors and systems onboard a vehicle. For example, a speedometer and a navigation system also provide information that may be used to determine vehicle acceleration. Audio signal processing may be carried out by the vehicle audio controller 106.

FIG. 2 is a block diagram showing a speaker layout 200 for an exemplary four channel sound system in the vehicle, The sound processing system described herein is applicable to a variety of sound systems and is described herein as four-channel system as an example only. The four-channel system may include a left front speaker 202, a right front speaker 204, a left rear speaker 206, and a right rear speaker 208. A listener 210, such as a driver is also shown for reference. The vehicle audio controller 106 provides surround sound processing of an incoming audio signal. In one example, the surround sound processing is accomplished using one or more matrices before being output to the speakers 202, 204, 206, 208. Incoming audio signals include, but are not limited to, channels such as input center, input front left, input front right, input rear left and input rear right.

The matrices may contain hardware, firmware and/or software algorithms to perform functions such as mixing, decoding, filtering, and/or gain adjustments for surround sound. The matrices receive selected channels of an incoming signal and more than one matrix may receive the same or different channels. The processed signals may be combined or mixed before being sent to the loudspeakers 202, 204, 206, 208 for output. For example, the side left output of one matrix may be combined with the left side output of another matrix. The audio sound system 106 (shown in FIG. 1) provides audio output signals for an enhanced perception of sound to the listener 210. In general, a more detailed description of one example of a surround sound system that may be used in accordance with the present disclosure is described in U.S. Pat. No. 7,443,987, also assigned to the present Assignee and incorporated herein by reference.

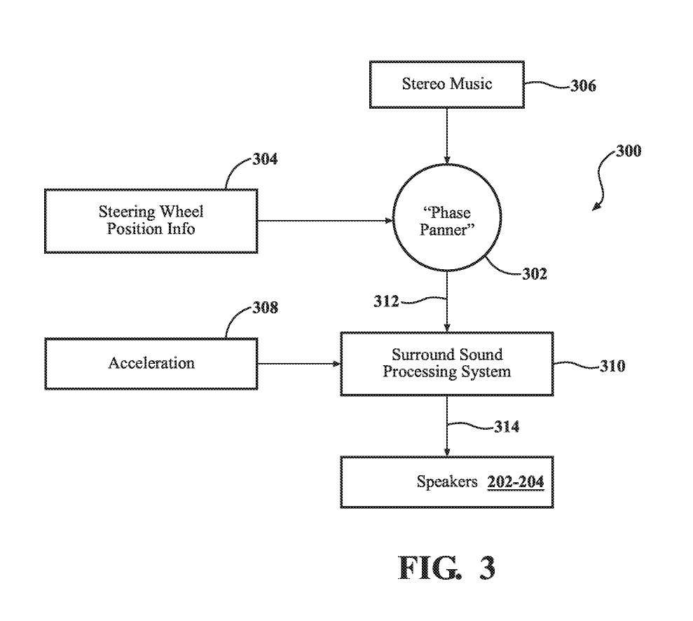

FIG. 3 generally depicts one exemplary block diagram 300 of an audio signal distribution system 332, also referred to herein as a phase patter, which may be carried out by the vehicle audio controller 106 (shown in FIG. 1). The phase panner 302 receives a signal 304 indicative of a vehicle heading. The vehicle heading may be a steering wheel position from a source such as a steering wheel position sensor. The phase panner 302 also receives an incoming audio signal 306, such as from a stereo or other source of audio in the vehicle. From the steering wheel position input 304, the panner 302 is able to determine a vehicle heading direction. A signal representative of a vehicle acceleration may also be provided. The acceleration input signal 308 may also be provided from an accelerometer on the vehicle. The acceleration input 308 is received directly by a surround sound processing system 310.

Depending on the vehicle heading as determined from the steering wheel position sensor and provided to the phase painter 302, the phase panner 302 generates a pan control signal 312. The pan control signal 312 is input to the surround sound processing system 310. The surround sound processing system 310 uses the pan control signal 312 to generate an output audio signal that is output to the loudspeakers 202-208. The surround sound processing system may also use the acceleration input signal 308 to process audio signals 314 that are then output to the loudspeakers 202-208.

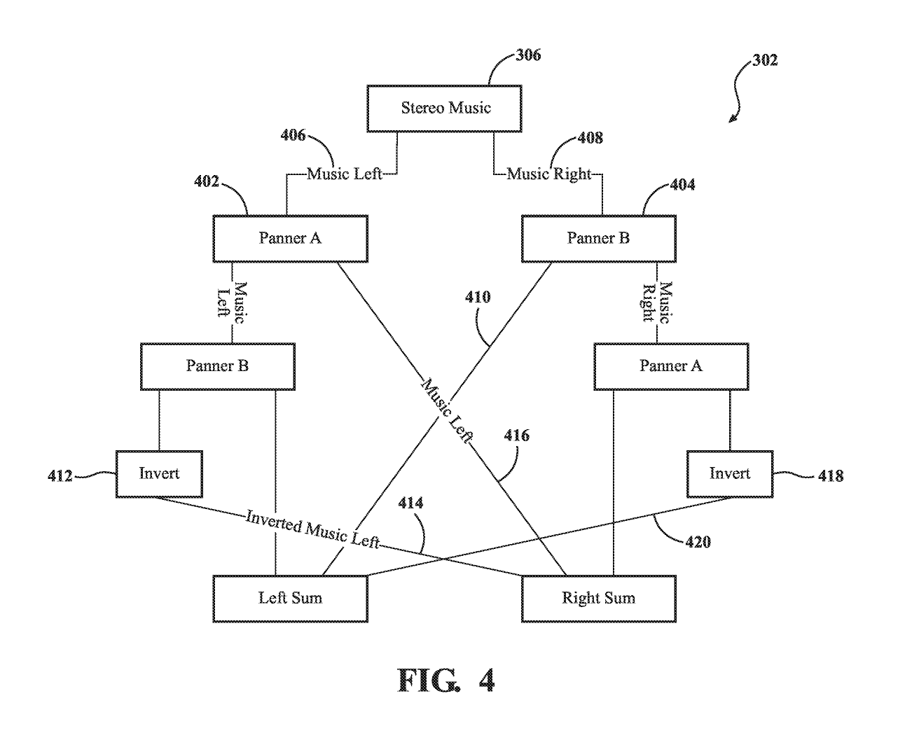

The phase panner 302 is shown in more detail in a block diagram in FIG. 4. The phase panner 302 is a dual panner with a first panner 402 and a second panner 404. For example purposes, the first panner 402 is associated with a left channel 406 of the audio source 306 and the second partner 404 is associated with a right channel 408 of the audio source 306. When input panning is centered (the vehicle steering wheel is centered), the left stereo signal goes to the left channel and the right stereo signal goes to the right channel.

As the vehicle heading changes, such as when the vehicle steering wheel is turned to the left, input panning also goes left. The first panner 402 is panning left. As the vehicle heading goes left of center, the second panner 404 also pans the right channel to the left 410. Furthermore, an inverse left channel 412 from the first partner pans to the right 414. The result is that the second panner 404 starts panning when input panning is past left from a center position.

Similarly, when the vehicle heading goes right, such as when the vehicle steering wheel is turned to the right, input panning goes right. The second panner is panning right. The first partner 402 also pans the left channel to the right 416. Furthermore, an inverse right channel 418 from the second panner 404 pans to the left 420.

Referring still to FIG. 4, when panning is centered, meaning the steering wheel is in a straight ahead position, the focus of the music is controlled as determined by the surround sound processing system. The focus of the music will be adjusted by the surround sound processing system in response to a pan adjustment control signal provided by the panner 302 as the route of the vehicle changes. For example, responding as the vehicle travels curves, tunnels and as the vehicle accelerates and/or decelerates, the audio will be connected to the overall driving experience. So as input from the steering wheel position moves to the left of the driver, input panning from the second panner 404 also shifts left. The first panner 402 will generate the inverted left panner signal 414. The mirror effect happens When input panning goes to the right, meaning the vehicle is steered to the right of center. The vehicle heading information as an input to the phase panner 302 allows the sound to be distributed in a manner that alters the localization and spatial illusion of the sound to produce a listening experience that is correlated to the driving experience.

Referring still to FIG. 4, the pan control signal adjustment when the vehicle is veering left incorporates a gain adjustment, art increase, for the left side loudspeakers, a gain adjustment, a decrease, for the right side loudspeakers and an inverted left-side gain signal adjustment that is applied to the right side loudspeakers. In all, the modifications are represented in a pan control adjustment that is input to the surround sound processing system. The pan control signal, as an input to the surround sound processing system, is used to modify the audio signal output at the surround sound processing system to modify the output to the loudspeakers so that the driving experience and the audio experience are connected.

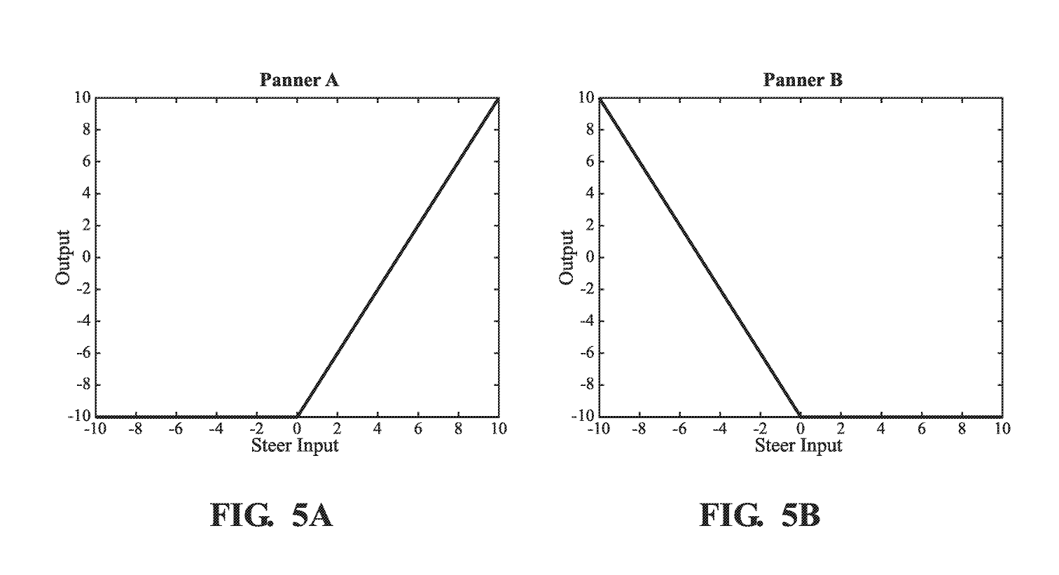

FIGS. 5A & 5B demonstrate first and second painter configurations for steering position input. A steer input is represented along the x-axis in each graph. 0 is center panning. −10 is defined to be a hard turn left and +10 is defined to be a hard turn right. The first partner, shown in FIG. 5A, starts panning to the right when input panning is right biased, or right of center. The second panner, shown in FIG. 5B starts panning to the left when a steering input is left biased, or left of center.

A vehicle acceleration and deceleration may also be incorporated into the surround sound processing system. Using a vehicle acceleration signal as an input allows not only left to right adjustments described above, but also front to rear adjustments and a “width” of the sound within the vehicle interior. For example, as the vehicle is accelerating or decelerating, the surround sound processing system uses the acceleration information to generate an audio output that compensates for the acceleration. For example, when the vehicle is accelerating a surround bias is implemented as opposed to a front bias which is also called “wrap”. The surround sound processing system can make adjustments to the audio signal for output for the loudspeakers by applying knowledge of the vehicle's acceleration to spatial extraction techniques associated with an audio signal. This is also applicable to adjusting the audio signal in response to a vehicle that is decelerating while turning. The result is a complete correlation of the audio experience and the driving experience as an enhancement. For example, volume and additional delay may be added to the loudspeaker output while the vehicle is accelerating. Reverb gain may be modified to add volume as the vehicle accelerates. Speakers in the vehicle may also include height speakers which gain and delay may also be adjusted according to acceleration/deceleration of the vehicle.

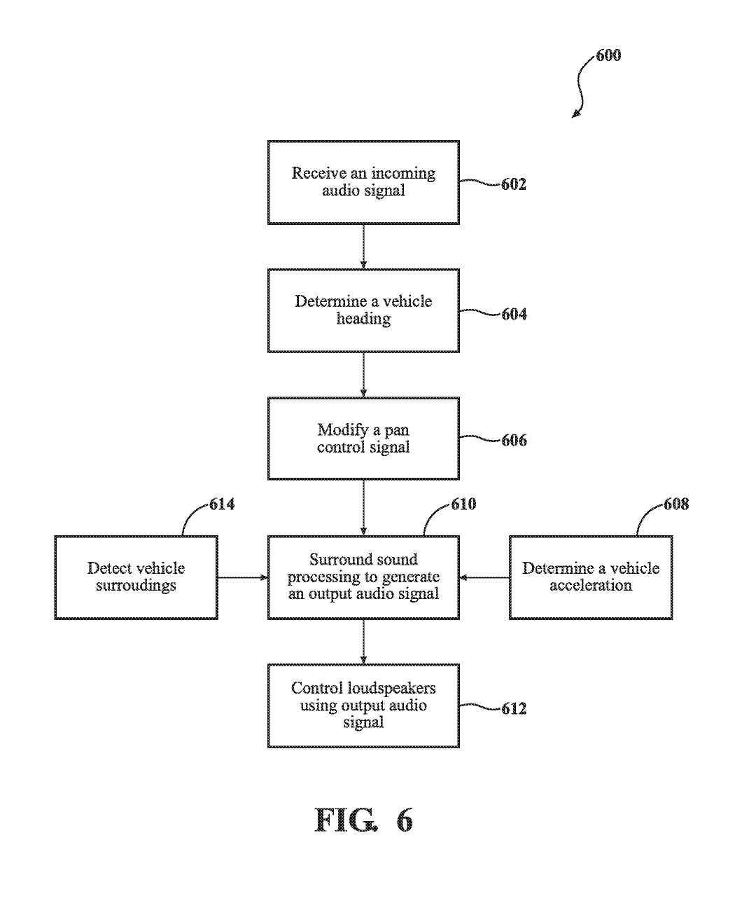

FIG. 6 is flowchart of a method 600 for audio distribution. The vehicle audio controller receives 602 an incoming audio signal to be processed for output at the loudspeakers in the vehicle sound system. A vehicle heading is determined 604. Based on the determined vehicle heading, a pan control signal is generated 606. The pan control signal modifies the gain settings for left and right loudspeakers in the vehicle in order to connect the driving experience to the audio experience. As the steering input changes, the pan control signal is used to adjust panning to compensate for the change in vehicle direction. The modified pan control signal is input 608 to the surround sound processing system, where an output audio signal is generated 610. The surround sound processing system may also accept and consider a vehicle acceleration when generating the output audio signal. A vehicle acceleration may be determined 608 and supplied to the surround sound processing system to generate 610 an output audio signal. The surround sound processing system may use both the modified pan control signal and the vehicle acceleration, it may use one or the other signal as well. The output audio signal generated by the surround sound system is used to control the output at the vehicle loudspeakers 612.

Standard vehicle audio systems create sound that makes a listener believe that the music is coming from straight ahead no matter what direction the car is actually moving. Therefore, When a vehicle is rounding a curve, audio is still perceived as coming from the center and may adversely affect the driving experience. The present disclosure determines the vehicle heading and steers the audio according to the steering and acceleration of the vehicle. Loudspeakers may be tuned and directed to connect the audio experience with the driving experience in a manner that enhances both experiences. The audio is incorporated into the momentum of the vehicle.

In yet another example of connecting audio to the driving experience, the present disclosure uses information about the vehicle's surroundings to steer the audio accordingly. Using inputs from vehicle sensors and beamforming technology, the sound distribution system may detect an environment of the exterior of the vehicle 614 such as the vehicle's surroundings when the vehicle is travelling through a tunnel. Then, for example, when a vehicle is entering and exiting a tunnel, adjustments are made to audio signal to compensate the audio signal and immerse the audio into the vehicle driving experience. The adjustments made by the sound processing system use spatial slices distributed into channels so as to create a wider or narrower, front or rear, sound effect within the vehicle.

In the foregoing specification, the present disclosure has been described with reference to specific exemplary embodiments. Various modifications and changes may be made, however, without departing from the scope of the present disclosure as set forth in the claims. The specification and figures are illustrative, rather than restrictive, and modifications are intended to be included within the scope of the present disclosure. Accordingly, the scope of the present disclosure should be determined by the claims and their legal equivalents rather than by merely the examples described.

For example, the steps recited in any method or process claims may be executed in any order and are not limited to the specific order presented in the claims. Any equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present disclosure, in addition to those not specifically recited, may be varied or otherwise particularly adapted to specific environments, manufacturing specifications, design parameters or other operating requirements without departing from the general principles of the same.

1. A sound signal distribution system comprising:
an audio system controller;
an input signal representative of a vehicle heading received at the audio system controller;
a pan control adjustment signal generated by the audio system controller and based on the input signal representative of the vehicle heading; and
a surround sound processing algorithm carried out in the audio system controller, the surround sound processing system receives the pan control adjustment signal and applies it to an incoming audio signal to generate an output audio signal supplied to at least one loudspeaker.

2. The system as claimed in claim 1 further comprising an input signal representative of a vehicle acceleration that is used by the surround sound processing algorithm along with the pan control adjustment signal to generate an output audio signal supplied to at least on loudspeaker.

3. The system as claimed in claim 2 further comprising at least one input signal representative of an environment exterior to the vehicle to be used by the surround sound processing algorithm along with the pan control adjustment signal and the input signal representative of a vehicle acceleration to generate an output audio signal supplied to at least one loudspeaker.

4. The system as claimed in claim 1 wherein the pan control adjustment signal generated by the audio system controller further comprises:
a first signal from a first panner panning in a first direction;
a second signal from a second panner panning in the first direction when the vehicle heading is detected to be off center in the first direction; and
an inverse signal from the first panner panning to a second direction.

5. The system as claimed in claim 1 wherein the vehicle heading is a steering angle.

6. A sound signal distribution system comprising:
an audio system controller having a first panner panning to a left channel and a second panner panning to a right channel;
an input signal representative of a vehicle heading received at the audio system controller;
a pan control adjustment signal generated by the audio system controller and the input signal representative of the vehicle heading;
wherein for a center vehicle heading, the pan control adjustment signal has a first panner signal panning to the left channel and a second panner signal panning to the right channel;
wherein for a left-of-center vehicle heading, the pan control adjustment signal has a first panner signal panning to the left channel, an inverse first panner signal panning to the right channel, and a second panner signal panning to the left channel;
wherein for a right-of-center vehicle heading, the pan control adjustment signal has a second panner signal panning to the right channel, an inverse second panner signal panning to the left channel, and a first panner signal panning to the right channel; and
a surround sound processing algorithm carried out in the audio system controller, the surround sound processing system receives the pan control adjustment signal and applies it to an incoming audio signal to generate an output audio signal supplied to at least one loudspeaker.

7. The system as claimed in claim 6 further comprising an input signal representative of a vehicle acceleration used by the surround sound processing algorithm along with the pan control adjustment signal to generate an output audio signal supplied to at least one loudspeaker.

8. The system as claimed in claim 7 further comprising at least one input signal representative of an environment exterior to the vehicle to be used by the surround sound processing algorithm along with the pan control adjustment signal and the input signal representative of a vehicle acceleration to generate an output audio signal supplied to at least one loudspeaker.

9. The system as claimed in claim 6 wherein the vehicle beading is a steering angle.

10. A method for distributing an audio signal of a sound system in a vehicle, the sound system having an audio system controller and a surround sound processing algorithm carried out in the audio system controller, the method comprising the steps of:
receiving an input signal representative of a vehicle heading;
generating a pan control adjustment signal that incorporates a gain adjustment based on the vehicle heading; and
receiving the pan control adjustment signal at the surround sound processing algorithm to generate an output audio signal at at least one loudspeaker in the vehicle.

11. The method as claimed in claim 10 wherein the step of receiving an input signal representative of a vehicle heading further comprises receiving a steering angle from a steering angle sensor on the vehicle.

12. The method as claimed in claim 19 wherein the step of generating a pan control adjustment signal that incorporates a gain adjustment based on the vehicle heading further comprises;
for a center vehicle heading, generating a first panner signal panning to the left channel and a second panner signal panning to the right channel;
for a left-of-center vehicle heading, generating a first partner signal panning to the left channel, an inverse first panner signal panning to the right channel, and a second panner signal panning to the left channel; and
for a right-of-center vehicle heading, generating a second painter signal panning to the right channel, an inverse second panner signal panning to the left channel, and a first panner signal panning to the right channel.

13. The method as claimed in claim 10 further comprising the steps of:
receiving a signal representative of a vehicle acceleration at the surround sound processing algorithm; and
generating an output audio signal at at least one loudspeaker in the vehicle using the pan control adjustment signal and the signal representative of the vehicle heading.

14. The method as claimed in claim 13 further comprising the steps of:
receiving a signal representative of an environment exterior to the vehicle at the surround sound processing algorithm; and
generating an output audio signal at at least one loudspeaker in the vehicle using the pan control adjustment signal, the signal representative of the vehicle acceleration and the signal representative of the environment.
